(19) United States
(12) Patent Application Publication
(10) Pub. No.: US 2011/0239103 A1
(43) Pub. Date: Sep. 29, 2011

(54) DETECTING VIRALITY PATHS AND SUPPORTING REFERRAL MONETIZATION

(75) Inventor: Marc E. Mercuri, Bothell, WA (US)

(73) Assignee: MICROSOFT CORPORATION, Redmond, WA (US)

(21) Appl. No.: 12/729,238

(22) Filed: Mar. 23, 2010

(51) Int. Cl. G06F 15/16; G06F 3/14; G06F 3/048

(52) U.S. Cl. 715/234; 709/203; 715/738

(57) ABSTRACT

A content embedding system allows publishers to expose and deliver embeddable content in a way that a referral path of the content can be traced to determine what steps led the content to the site(s) on which the content is hosted. Content typically makes its way across the Internet in multiple steps, being passed from one user to another and one site to another. In addition to providing insight into how content is being shared across the web, the system also puts in place the tools to provide referral revenue for sites that drive significant consumption of content. Thus, the system allows a content publisher to track how his content is being consumed on various sites on a network, and to perform actions based on the tracked consumption, such as rewarding prolific distributors.

### BACKGROUND

The Internet is filled with many different types of content, such as text, video, audio, and so forth. Many sources produce content, such as traditional media outlets (e.g., news sites), individual bloggers, retail stores, manufacturers of products, and so forth. Some web sites aggregate information from other sites. For example, using a Really Simple Syndication (RSS) feed, a web site author can make content available for other sites or users to consume, and an aggregating site can consume various RSS feeds to provide aggregated content.

The production of content is time consuming and often costs money. Internet content is monetized in various ways. For example, traditional news sites may pay authors a salary to write articles just as they formerly did for newspapers and other print media. Similarly, a television news station may make audiovisual content available on its website that provides clips of its television shows that are monetized via interstitial ads and/or display ads on the containing page. Individual bloggers often monetize their content by hosting advertisements provided by content-based advertising providers. For example, a blog author may reserve a fixed size rectangle on a portion of his web site and embed an advertising provider's script or control to populate the rectangle with advertisements related to the page content upon access of the page by a reader. This model works well where the content author is displaying the content on a site under her control.

Today, content is provided in a publisher to consumer direct model. A consumer visits the publisher's site and clicks an embed button. That button creates an ‘embed tag’ that allows the consumer to place the published content (e.g., a YouTube video) on his own site. Once published on the consumers site, others may click an embed button and generate their own ‘embed’ tag. Today, these tags are typically consistent (e.g., one embed script for all people who wish to syndicate the content). There is no acknowledgement of the path by which the consumer received the content. Authors or publishers of content would often like to know how their content has spread throughout the Internet, but it is not straightforward to discover this in an automated fashion. The publisher can determine where requests originate from (i.e., the final site(s) on which the content is embedded), but not how the content got there. In addition, the publisher cannot provide appropriate credit to successful content distributors or encourage future distribution through monetary compensation without determining the distributor's identity.

### SUMMARY

A content embedding system is described herein that allows publishers to expose and deliver embeddable content in a way that a “virality path” of the content can be traced to determine what steps led the content to the site(s) on which the content is hosted. Content typically makes its way across the Internet in multiple steps, being passed from one user to another and one site to another. In addition to providing insight into how content is being shared across the web, the system also puts in place the tools to provide referral revenue for sites that drive significant consumption of content. The system is a mechanism by which to track the way that content is consumed and shared across the web. This provides value in determining how content is shared, determining who influences content distribution, and provides the ability to incentivize sites consuming embedded content to drive downstream sharing of the content. Thus, the system allows a content publisher to track how his content is being consumed on various sites on a network, and to perform actions based on the tracked consumption, such as rewarding prolific distributors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the content embedding system, in one embodiment.

FIG. 2 is a flow diagram that illustrates processing of the embed creation component of the content embedding system, in one embodiment.

FIG. 3 is a flow diagram that illustrates processing of the content request component of the content embedding system, in one embodiment.

FIG. 4 is a flow diagram that illustrates processing of the reporting component of the content embedding system, in one embodiment.

### DETAILED DESCRIPTION

A content embedding system is described herein that allows publishers to expose and deliver embeddable content in a way that a “virality path” of the content can be traced to determine what steps led the content to the site(s) on which the content is hosted. Viral marketing refers to grass roots distribution of content across the Internet, and a virality path tracks the movement of content from user to user or site to site. Content typically makes its way across the Internet in multiple steps, being passed from one user to another and one site to another. For example, a user may view an interesting video and email it to a friend who then places the video on his blog. A blog reader may subsequently pick up the video and cover the video in the reader's own blog, and so on. In addition to providing insight into how content is being shared across the web, the system also puts in place the tools to provide referral revenue for sites that drive significant consumption of content. The system is a mechanism by which to track the way that content is consumed and shared across the web. This provides value in determining how content is shared, determining who influences content distribution, and provides the ability to incentivize sites consuming embedded content to drive downstream sharing of the content.

In some embodiments, the content embedding system provides embeddable content along with an embed generation control (e.g., a button) that, upon activation, will generate an embed string that encodes a path of the content. The embed string includes an identification of the source site where the control was activated, a content identifier that identifies the content, a referring site, and a new site identifier for the newly created embed. For example, when an embed button is pressed, the system may generate a new embed string and store the string or information about the new site in a database controlled by the original content creator/publisher. Each time that embed URL is accessed, the system records consumption statistics (e.g. time, content identifier, referred-by publisher identifier, current content publisher's identifier, browser, OS, and so on). A combination of the content identifier, publisher identifier, and referred-by publisher identifier can be used in queries that self-join to the same database table that contains them to perform statistics that define the virality path. Thus, the system allows a content publisher to track how his content is being consumed on various sites on a network, and to perform actions based on the tracked consumption, such as rewarding prolific distributors.

The following provide examples of URL schemes that the content embedding system can expose for content consumers. A first URL, “http://www.contoso.com/contentid/_/A” references content stored at the domain name system (DNS) address www.contoso.com. The URL refers to content with a label (or content identifier) of “contentid.” The underscore (‘_’) in this example indicates that the embed for this content reference was provided by the original publisher. The A indicates the identifier created for the site on which the content is now hosted. Thus, in this example, the system appends a “from” and “to” identifier onto the end of a traditional content URL, although other schemes are possible, such as encoding the information in a numeric identifier resolvable using a publisher data store. A second URL, “http://www.contoso.com/contentid/A/C” references content published on site C and identifies that it was originally retrieved from site A. A third URL, “http://www.contoso.com/contentid/C/E” references content published on site E and identifies that it was originally retrieved from site C. As can be seen in this example, a path of one instance of the content can already be traced from the publisher's site to site A, then to site C, then to site E. Content may take a virtually limitless number of paths from the publisher's site to other sites, but all can be tracked in the publisher's database using the system described herein.

In some embodiments, the content embedding system provides an embeddable widget that includes content that one or more sites want to reference along with embedding logic for other sites that want to refer to the content. Providing this information in a single widget or control prevents a site from removing the embedding logic to circumvent the system and preserves the reliability of usage information received by the publisher.

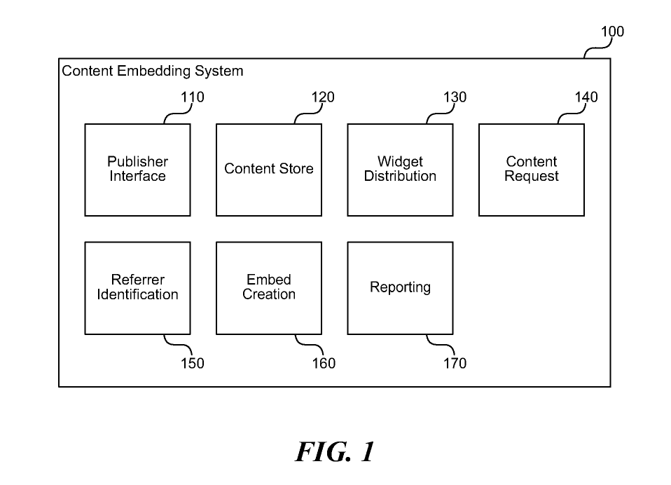

FIG. 1 is a block diagram that illustrates components of the content embedding system, in one embodiment. The system 100 includes a publisher interface component 110, a content store 120, a widget distribution component 130, a content request component 140, a referrer identification component 150, an embed creation component 160, and a reporting component 170. Each of these components is described in further detail herein.

The publisher interface component 110 provides an interface between a publisher and the system through which the publisher can add content to the system for distribution to one or more sites in a way that allows tracking further distribution of the content to other sites. The publisher interface component 110 may receive various content types from the publisher and store the content in the content store 120. The publisher may configure whether content will display associated information for a referrer to embed the content on the referrer's own site.

The content store 120 is a data store that provides persistent storage for content added to the system by the publisher. The content store 120 may include a file system, database, storage area network (SAN), cloud-based storage service, or any other type of storage technology or combination of storage technology that allows the publisher to store content and referrers to retrieve content for embedding in their own sites. The content store 120 may also comprise multiple content stores (e.g., multiple content databases). For example, in a broker scenario a broker provides content on behalf of partners and that broker provides an implementation of the content store 120 used by the system 100.

The widget distribution component 130 provides an interface through which referrers can request a widget that displays the publisher's content and trackable embedding information. For example, the widget distribution component 130 may supply a widget to referrers in the form of an ActiveX control, MICROSOFT™ SILVERLIGHT™ application, JavaScript, Adobe Flash, or other embeddable widget that a referrer can display along with other content. For example, the referrer may publish a web site that aggregates articles and audiovisual content related to a particular topic, and the referrer may embed the widget for content from a variety of publishers that provide content. In addition, frameworks such as MICROSOFT™ SILVERLIGHT™ and Adobe Flash may provide standalone hosts in which applications designed for these platforms can run without a browser or HTML, and the widget described herein may be incorporated into or used with such frameworks. The widget may also be provided by a third party (e.g., Microsoft or other software company), and each publisher may expose content in a format accessible by the third party widget. Web pages or other content pages can embed the widget along with parameters that specify where to access a particular publisher's content.

The content request component 140 receives requests to access the publisher's content from one or more referrers, wherein the request includes information for tracking a path of the content from the publisher's site to a referrer's site. The referrer may request content when a user accesses the referrer's web site and requests a web page that includes embedded content from the publisher. The referrer may identify the requested content by a content identifier, a globally unique identifier (GUID), or other tag or identifier that distinguishes one content item from another. The referrer may also provide other information, such as a source from which the referrer obtained the content, which the publisher can use to determine the path the content took to end up on the referrer's site.

The referrer identification component 150 identifies a referrer associated with a particular content request and extracts the information for tracking the path of the content from the request. For example, the request may include a URL that includes a query string or virtual path that encodes information that identifies the referrer and a source from which the referrer obtained the content. The referrer identification component 150 may log information about the request in the content store 120 or another store for later processing, such as to generate reports and determine popular referral sources. When the content request component 140 receives a new content request, the component 140 invokes the referrer identification component 150 to identify and store information about the request.

The embed creation component 160 receives requests to embed a content item on a referrer site and creates an embed tag that includes tracking information for identifying the referrer site and a site that provided the content to the referrer. The embed creation component 160 may be invoked by a button associated with a widget embedded on a web page or through another type of request (e.g., a web service application programming interface (API)) to generate a Hypertext Markup Language (HTML) embed tag or other type of embedding directive that allows the content item to be included in a referrer's content site. Upon receiving a request, the embed creation component 160 identifies the referrer site, creates a referrer identifier, identifies the source site and obtains any source identifier, and creates a URL for the referrer site to include in an embedding directive that, when accessed, allows the publisher to determine a referrer site that is accessing the content and how the referrer site obtained the content.

The reporting component 170 provides historical tracking information based on a record of content requests so that a publisher can identify popular referral sources for the publisher's content. The reporting component 170 allows the publisher to determine nodes in a tree of content distribution that are common to many virality paths. For example, the component 170 may determine that a publisher's video has reached a million hits per day, and that the video took a path through a first Twitter user that has 2 followers and a second Twitter user that has 500 followers. Although the high follower user may be well known and recognizable, the low follower user may actually be a better target for obtaining broad exposure to a wide audience. Because of the smaller audience of the low follower user, advertising or spreading content through that user may also be cheaper than the more popular high follower user. The reporting component 170 may also drive payment processing for the publisher to provide referral revenue based on a level of influence of each referrer or of particular referrers. For example, if a referrer is near the root of a tree of broad content distribution, the publisher may want to reward that referrer for good distribution results. A referrer may have an agreement with the publisher in advance that the referrer will be paid a particular amount of money for each content request that stems from the referrers distribution of the content. How the referrer distributes the content is up to the referrer, such as placing the content on one or more sites managed by the referrer or emailing the content to each of the referrer's contacts.

The computing device on which the content embedding system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

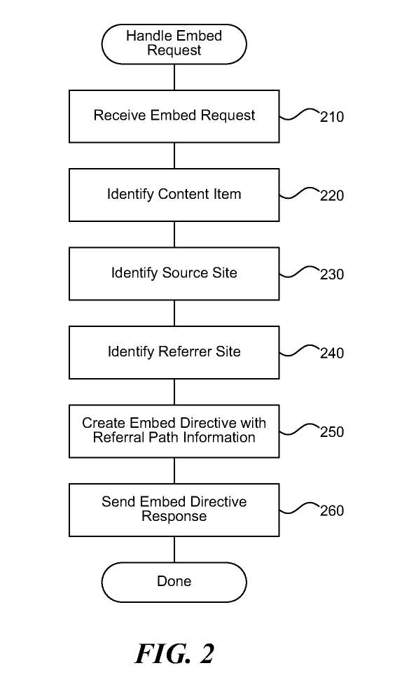

FIG. 2 is a flow diagram that illustrates processing of the embed creation component of the content embedding system, in one embodiment. Beginning in block 210, the component receives a request to create an embed directive for embedding content within a referrer site. For example, a referrer may access a content item on a source site and click an embed button to generate an embed directive for including the content item on the referrer's site. The content item and embed button may be part of a display produced by a widget associated with the system or using standard HTML or other specification language. The component may receive the request using standard protocols, such as via a Hypertext Transfer Protocol (HTTP) request, Simple Object Access Protocol (SOAP) request, and so forth or proprietary protocols.

Continuing in block 220, the component identifies a content item associated with the received request. For example, if the referrer viewed content on a source site and clicked an embed button, the embed button may have generated the request including a parameter describing the content item, such as by using a content identifier. A publisher's site may include a content store that identifies each content item provided by the publisher's site in a way that content items can be referenced and distinguished using a numeric or text identifier. Requestors that want to access a content item provide an appropriate identifier in the request. Thus, the component extracts the content identifier from the request. In some embodiments, the content identifier may make up part of a URL that references the content item.

Continuing in block 230, the component identifies a source site associated with the received request. For example, if the content item is a web-hosted video, and a referrer clicks an embed button, client-side script associated with the embed button may embed an identifier associated with the source site as part of the embed request. As another example, the content embedding system may have encoded information about the source site in response to an earlier request to embed the content at the source site, and may have provided a URL for the source site to provide along with new requests to embed the content on a referrer site. Thus, the component extracts the source site from the request. At the first level of distribution, the source site may be the publisher's own site, in which case the component receives information identifying the publisher's site as the source.

Continuing in block 240, the component identifies a referrer site associated with the received request. A referrer may provide information on a web form or a widget associated with the system may automatically determine information about the referrer (e.g., by capturing an Internet Protocol (IP) address or other available information about the referrer). Generating the embed request may also direct the referrer to a web page or other resource of the publisher so that the referrer can provide information and receive an embed directive.

Continuing in block 250, the component creates an embed directive that includes path information specifying the identified content item, the identified source site, and the identified referrer site. For example, the component may build a URL for accessing the content item that includes information about the content item, the source, and the referrer embedded in the URL. The component may also log information (not shown) in a content store describing the new embed directive so that information about the circumstance of the directive's creation is available for subsequent reporting and analysis.

Continuing in block 260, the component sends a response to the received request that includes the created embed directive. For example, the response may include HTML or other language code for embedding the content item on a page of the referrer's site in a manner that accesses of the content item include trackable virality path information that the publisher can use to determine a referral path associated with content access requests. The component performs these steps each time the content item is passed along and a request to embed the content item at a new site is received. After block 260, these steps conclude.

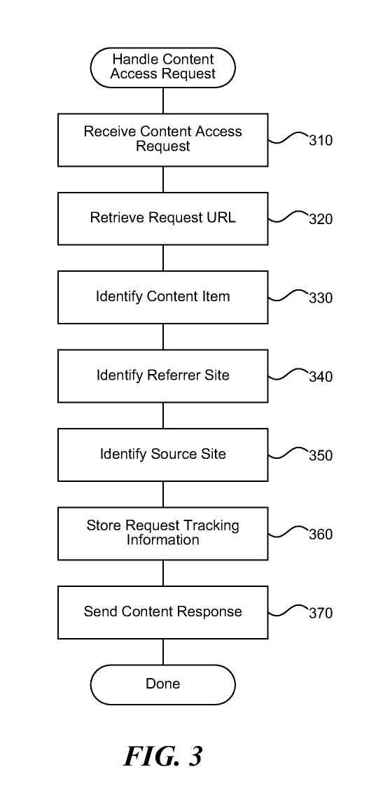

FIG. 3 is a flow diagram that illustrates processing of the content request component of the content embedding system, in one embodiment. Beginning in block 310, the component receives a request to access a content item, wherein the request includes a content identifier and information from which a referral path of the content can be derived. For example, the request may originate from a client browser because of displaying a web page that includes embedded content from a publisher. The publisher receives the content request based on a URL or other information in the embedded content that references the publisher. To determine where requests for content came from, the publisher may encode information in URLs referencing the publisher's content. Those of ordinary skill in the art will recognize that the steps described herein can be reordered or performed in parallel to achieve similar results. For example, the system may identify the source site before identifying the referrer site.

Continuing in block 320, the component retrieves a URL associated with the received content request. For example, if the request is an HTTP request then the URL is a standard portion of the request and is accessible by the component. The URL may include virtual paths and/or a query string that provide information about the request. For example, the request may include a content item identifier and “breadcrumbs” or other path-specifying information that allows the publisher to determine the referral path through which the client ended up accessing the requested content item.

Continuing in block 330, the component identifies the content item associated with the retrieved URL. For example, the URL may include a content identifier as a virtual directory portion of the URL. Web sites are typically organized using standard file system concepts such as folders and files. However, a path specified by a request need not necessarily mirror a physical path stored on a web server. Rather, a web server can pre-process a received path to provide any number of semantic meanings to a virtual path desired by a web author so that the author can embed information in the URL virtual path that is useful for the web author to track useful information. Thus, the content identifier may be included in the URL in a variety of ways, as those of ordinary skill in the art will recognize.

Continuing in block 340, the component identifies a referrer site associated with the retrieved URL. For example, as with the content identifier, the URL may include a referrer site identifier created earlier by the system in response to an embed request. The system may assign a numeric or other identifier to each referrer site that requests an embed directive from the system. When the component receives a request to access a content item, the system can retrieve an earlier provided referrer site identifier to identify a referrer site associated with the content access request.

Continuing in block 350, the component identifies a source site associated with the retrieved URL, wherein the source site identifies a site from which the referrer previously discovered an embeddable instance of the content item. For example, the URL may include a source site identifier that the system assigned to the source site in response to an embed request when the source site embedded the content item. The combination of the source site and referrer site provides a link that defines part of the content item's virality path in reaching the referrer's site. Earlier portions of the path may be included in the URL or may be derived from stored information in the content store. For example, just as there is an entry in the content store that identifies the source site as providing the content item to the referrer site, there will also be an entry in which the source site is a referrer and an earlier source provided the content to the source site. By following these links, a full tree can be produced starting with the publisher's site and branching out along each referral path that the content took.

Continuing in block 360, the component stores tracking information about the received request. For example, the component may store a time of the request, information about the client, the content identifier, the source identifier, the referrer identifier, and so forth. Alternatively or additionally, the system may maintain a data row that describes a particular pair of source site and referrer site and a hit count that the component increments upon receiving each request to access the content item that specifies that pair. This allows the system to determine which links are generating the most hits and thus which referral paths have been the most fruitful.

Continuing in block 370, the component sends a content response that includes the requested content item retrieved from the content store. For example, if the original request is an HTTP GET request, then the response may be a standard HTTP response (e.g., 200 OK) with a payload that contains the requested content item (e.g., an image, video, or other embeddable content). These steps repeat each time a client accesses a content item. After block 370, these steps conclude.

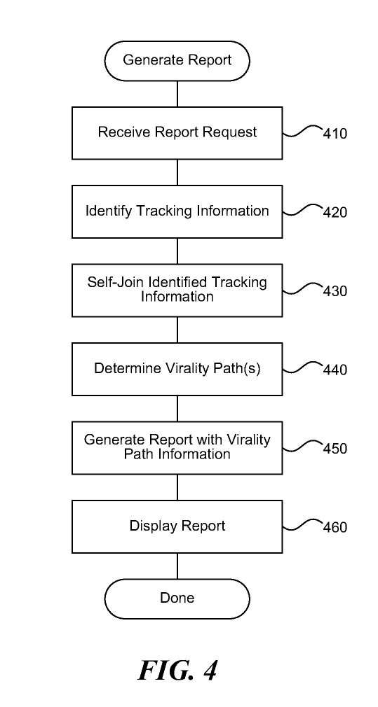

FIG. 4 is a flow diagram that illustrates processing of the reporting component of the content embedding system, in one embodiment. Beginning in block 410, the component receives a request to generate a report describing accesses of a content item. For example, a publisher may access a reporting web page or other user interface of the content embedding system where the publisher can request various types of reports about content distributed by the system. Continuing in block 420, the component identifies tracking information in a data store containing access information about the content item, wherein the tracking information describes at least one completed client access of the content item. For example, the data store may be a database that includes a row for each client access of a content item or rows related to links in a referral path of the content item that include hit counts that cumulatively track accesses of the content item.

Continuing in block 430, the component performs a self-join to produce a referral path from tracking information describing individual links of the content item from at least one source site to at least one referrer site that embedded the content item. For example, each entry in the data store may describe one pair of source site and referrer site, and the system may join this information in a chain starting with the publisher's site and following links to arrive at the referrer's site. The system can combine tracking information using techniques other than a self-join, and a self-join is used herein as one example of how the system can identify related data about a content item.

Continuing in block 440, the component determines one or more virality paths through which the content item has been accessed. Content on the Internet or other networks may be distributed in many different ways (e.g., email, blog links, Twitter posts, and so forth) and may be passed along many times (e.g., from a news site, to an individual's blog, to followers of the individual). A virality path defines a complete chain linking the publisher's site that originally provided the content to one or more intermediate sites and ultimately to one or more referrers' sites. Content may be accessed through a variety of virality paths and the system may track which virality paths lead to the most accesses of a particular content item.

Continuing in block 450, the component generates a report based on the determined virality paths. The system may include many types of reports, including pre-defined reports and reports customized by a user of the system. The report may include textual information, such as tables of data, as well as visual depictions of virality paths (e.g., a tree view with branches representing each path). Continuing in block 460, the component displays the generated report. For example, the system may provide reports through a reporting web page and the component may display the generated report as a dynamically generated web page for viewing virality path information. In some embodiments, the system provides an API through which applications or other software components can access the system. Thus, the system may receive requests programmatically that specify one or more reports to generate and provide in response to an API call. After block 450, these steps conclude.

In some embodiments, the content embedding system stores a complete virality path in the URL of content embedded at a site. Using this variation, the system can reduce the amount of data stored in the publisher's database and examine the URL of references that result in accesses to the publisher's site when those references are received. Building on previous examples herein, one implementation appends each new referring site onto the end of a content URL. For example, a content item passed from a publisher's site-to-site A to site B might have the URL, “http://www.contoso.com/_/A/B.” Many references to content may not turn out to be all that widely viewed, and this variation saves the publisher's database from consuming resources storing information about sites through which no access is ever received. Because publisher's may worry about manipulation and security of the URL, the system may encode the virality path information in a manner that is less manipulable (e.g., by converting the text string to a numeric value).

In some embodiments, the content embedding system provides an API through which aspects of the system described herein can be invoked or accessed. For example, the system may provide a web service API for generating new embed strings, and the system may entrust a particular content distributor to invoke the API and generate embed strings for each consumer to which the distributor provides a content item. The system may also receive new content from a publisher and requests to generate reports through a publisher API. Where the description herein provides for access by a user or display to a user, those of ordinary skill in the art will recognize that the system can provide similar programmatic access to enable complex solutions built with the system herein as a building block.

In some embodiments, the content embedding system incorporates payment processing for referrers. The system can use many different models for monetization. Once the referral path information is available as described herein, it is possible to compensate each referrer according that that referrer's contribution to the spreading of the content. For example, the system can determine how many hits occurred because of the referrer's distribution of the content and can pay the referrer per hit. In addition, the system can identify pivotal referrers from which many referral path branches emanate and can compensate those referrers for their ability to achieve widespread dissemination of content.

From the foregoing, it will be appreciated that specific embodiments of the content embedding system have been described herein for purposes of illustration, but that various modifications may be made without deviating from the spirit and scope of the invention. Accordingly, the invention is not limited except as by the appended claims.

I/We claim:

1. A computer-implemented method for creating a link to embeddable content that provides referral path tracking information, the method comprising:
receiving a request to create an embed directive for embedding content within a referrer site;
identifying a content item associated with the received request;
identifying a source site associated with the received request;
identifying a referrer site associated with the received request;
creating an embed directive that includes path information specifying the identified content item, the identified source site, and the identified referrer site; and
sending a response to the received request that includes the created embed directive,
wherein the preceding steps are performed by at least one processor.

2. The method of claim 1 wherein receiving the request comprises receiving an indication that a referrer accessed a content item on a source site and invoked an embed control to generate an embed directive for including the content item on the referrer's site.

3. The method of claim 1 wherein receiving the request comprises receiving the request from an embeddable widget that includes the content item and a control for requesting to embed the content item on another site.

4. The method of claim 1 wherein identifying the content item comprises extracting a content identifier from information provided in the received request.

5. The method of claim 1 wherein identifying the content item comprises accessing a URL associated with the request that encodes information about the content item.

6. The method of claim 1 wherein identifying a source site comprises extracting a source site identifier from a URL associated with the requested request.

7. The method of claim 1 wherein identifying a source site comprises identifying a publisher's site as the source of the content item.

8. The method of claim 1 wherein identifying a referrer site comprises receiving a referrer identifier as part of the received request.

9. The method of claim 1 wherein identifying a referrer site comprises automatically determining the referrer site based on the request.

10. The method of claim 1 wherein creating the embed directive comprises building a URL for accessing the content item that includes information about the content item, the source site, and the referrer site embedded in the URL.

11. The method of claim 1 wherein creating the embed directive comprises generating Hypertext Markup Language tags that include information for accessing the requested content item.

12. The method of claim 1 further comprising, after creating the embed directive, logging information in a content store describing the new embed directive so that information about the circumstance of the directive's creation is available for subsequent reporting and analysis.

13. The method of claim 1 wherein sending the response comprises sending HTML code for embedding the content item on a page of the referrer's site in a manner that accesses of the content item include trackable virality path information that the publisher can use to determine a referral path associated with content access requests.

14. A computer system for tracking and monetizing distributed content on the Internet, the system comprising:
a processor and memory configured to execute software instructions;
a publisher interface component configured to provide an interface between a publisher and the system through which the publisher can add content to the system for distribution to one or more sites in a way that allows tracking further distribution of the content to other sites;
a content store configured to provide persistent storage for content added to the system by the publisher;
a widget distribution component configured to provide an interface through which one or more referrers can request a widget that displays the publisher's content and trackable embedding information;
a content request component configured to receive requests to access the publisher's content from one or more referrers, wherein the request includes information for tracking a path of the content from the publisher's site to a referrer's site;
a referrer identification component configured to identify a referrer associated with a particular content request and extract the information for tracking the path of the content from the request; and
an embed creation component configured to receive requests to embed a content item on a referrer site and create an embed tag that includes tracking information for identifying the referrer site and a site that provided the content to the referrer.

15. The system of claim 14 wherein the content request component is further configured to extract a content identifier, a source site identifier, and a referrer site identifier from a received content access request.

16. The system of claim 14 wherein the referrer identification component is further configured to log information about the request in the content store for later processing.

17. The system of claim 14 wherein the embed creation component is further configured to, upon receiving a request, identify a referrer site associated with the request, create a referrer identifier, identify a source site and obtain a source identifier, and create a URL for the referrer site to include in an embedding directive that, when accessed, allows the publisher to determine a referrer site that is accessing the content and a referral path through which the referrer site obtained the content.

18. The system of claim 14 further comprising a reporting component configured to provide historical tracking information based on a record of content requests so that a publisher can identify popular referral sources for the publisher's content and pay a fee to at least one referrer.

19. A computer-readable storage medium comprising instructions for controlling a computer system to respond to a content request and track information about a referral path of the request, wherein the instructions, when executed, cause a processor to perform actions comprising:
receiving a request to access a content item, wherein the request includes a content identifier and information from which a referral path of the content can be derived;
retrieving a URL associated with the received content request;
identifying the content item associated with the retrieved URL;
identifying a referrer site associated with the retrieved URL;
identifying a source site associated with the retrieved URL, wherein the source site identifies a site from which the referrer previously discovered an embeddable instance of the content item;
storing tracking information about the received request in a data store; and
sending a content response that includes the requested content item retrieved from the data store.

20. The medium of claim 19 wherein the information from which a referral path of the content can be derived includes a URL that comprises a content identifier, a source site identifier, and a referral site identifier.
